(19) United States
(12) Patent Application Publication
(10) Pub. No.: US 2003/0023775 A1
(43) Pub. Date: Jan. 30, 2003

(54) Efficient notification of multiple message completions in message passing multi-node data processing systems

(75) Inventors: Robert S. Blackmore, Poughkeepsie, NY (US); Amy Xin Chen, Poughkeepsie, NY (US); Kevin J. Gildea, Bloomington, NY (US); Rama K. Govindaraju, Poughkeepsie, NY (US); Anand V. Hudli, Hopewell Junction, NY (US); Radha R. Kandadai, Lake Katrine, NY (US); Chulho Kim, Poughkeepsie, NY (US); Gautam H. Shah, Poughkeepsie, NY (US)

Correspondence Address: LAWRENCE D. CUTTER, IBM Corporation, Intellectual Property Law Dept., 2455 South Rd., M/S P386, Poughkeepsie, NY, 12601, US

(73) Assignee: INTERNATIONAL BUSINESS MACHINES CORPORATION, ARMONK, NY (US)

(21) Appl. No.: 09/904,815

(22) Filed: Jul. 13, 2001

(51) Int. Cl. G06F 9/00; G06F 9/46

(52) U.S. Cl. 709/330; 709/313; 709/318; 709/328

(57) ABSTRACT

A system and method for message processing in a distributed, multi-node data processing system is structured to permit a sending process running on one node to send messages to a selectable subset of nodes via an interface mechanism which places a sending process in an inactive or idle state pending receipt of either all responses from the selected destination nodes or of a notification via the interface that one or more responses will not arrive.

### BACKGROUND OF THE INVENTION

The present invention is generally directed to message passing protocols in multi-node data processing systems. More particularly, the present invention is directed to an improved method for passing messages to multiple nodes in a distributed data processing system with particular attention given to the situation in which responses to the messages are determined not to be forthcoming. In particular, the present invention permits the sending process to remain in an idle state which does not consume CPU resources when waiting for responses. It remains in the idle state until it is determined that either responses to all of the messages from the other nodes have arrived or that messages which have not arrived will never arrive due to various failure modalities. In particular, the present invention avoids the need for active polling of the sending process by the CPU to check for message completion as each message arrives. More particularly, the present invention provides a message passing method usable in a system of clustered nodes which can specifically identify those nodes from which a response is required. Accordingly, it is seen that the present invention provides a method for selectively sending specific messages to a plurality of nodes in a multi-node system while at the same time providing an efficient mechanism to wait for responses. Even more particularly, the present invention defines an interface model that permits the desired protocol to be implemented efficiently without requiring the CPU in the sending node to reawaken the sending process upon receipt of each message back from a receiving node. It is thus seen that the present invention provides a mechanism, protocol, and an interface specification in which CPU cycles are not consumed while waiting for responses. And in particular, it is seen that the present invention avoids active polling of the sending process or even polling of the receiving nodes.

### SUMMARY OF THE INVENTION

An accordance with a preferred embodiment of the present invention a method for message passing in a distributed data processing system which includes a plurality of nodes comprises a first step of sending a message from a process running on one of the nodes in the system to an identified plurality of other nodes. In a second process step the status of the sending process is set to idle and in a third and last process step the idle status of the calling process is changed to active upon the receipt of responses to said message either from all of the nodes to which the message was sent or upon receipt of notification that at least one response from the destination nodes will not arrive.

The interface which provides the semantic foundation for the steps recited above includes the definition of two interface “calls,” in addition to the existing API's which allow the parallel application to initialize a counter value and to list the destination nodes to which a request message is to be sent and from which a response is expected. Following the use of this first interface call, a process employs existing message passing functions in the Low Level Application Program Interface Subsystem (LAPI) which exists as part of the support for the General Parallel File System (GPFS) and for other parallel applications in the IBM p-series product line (previously identified as the RS/6000 SP System). These existing message passing functions are used to send requests to the various nodes specified via the first of two new LAPI interface specification elements. The user then makes a second new interface call to a specific LAPI function which instructs the messaging system to put the thread which is making the call to sleep and to be woken up when one of the following conditions occur: (1) all of the responses from the nodes expected have arrived; or (2) some of the responses have arrived and the remaining responses are indicated as never arriving because the node from which a response is expected or the communication link through which the message travels has failed in some way. The method through which this determination is made and the corresponding interface is described in the patent application titled “Recovery Support for Reliable Messaging” and bearing Docket No. (POU920000146US1) filed concurrently herewith and incorporated herein by reference. In preferred embodiments, the second LAPI function call (LAPI_Nopoll_wait; see Appendix I) also provides an indication that a response was already received before a target node failed. This flexibility and a mechanism to provide an indication for state of “message existing within the system,” allows an application to recover from node (or communication link) failures and to be able to resume application execution in a very efficient manner. The second of the new LAPI function calls (LAPI_Nopoll_wait) is architected to enable it to be implemented in a manner that no CPU cycles are consumed by the waiting thread while waiting for the requested responses to arrive. This is in particular quite different from the TCP/IP protocol which provides a mechanism in which the calling process is woken every time any one of the messages completes or when a time out occurs. This TCP/IP mechanism is not the most efficient mode of operation since it causes a wake up upon every message completion. In contrast, the present message protocol is not only more versatile, it is also significantly more efficient.

Accordingly, it is an object of the present invention to provide a message passing protocol for use in a distributed multi-node data processing system.

It is yet another object of the present invention to provide a simple and efficient interface structure, commands, and calls to be employed by sending or calling processes or by threads.

It is also an object of the present invention to eliminate the reawakening of a calling process every time that a message is returned to that process as a result of an earlier message sent by that process.

It is yet another object of the present invention to provide a mechanism which allows message sending processes to enter an idle state which consumes no CPU cycles.

It is also another object of the present invention to provide an interface, specification, and architecture for message passing in a distributed data processing system having a plurality of nodes.

It is a still further object of the present invention to provide an improved message passing protocol in multi-node systems in which there is one sender node and a plurality of receiver nodes.

It is also an object of the present invention to provide efficient programming hooks to facilitate recovery from system failures.

It is a still further object of the present invention to provide an interface structure which still allows senders to use standard message passing interface calls in order to send messages to identified receivers.

It is also an object of the present invention to provide a mechanism by which a sending node specifically identifies nodes which are to receive a message and concomitantly to identify nodes from which responses are expected.

Lastly, but not limited hereto, it is an object of the present invention to provide a message passing protocol which permits the message sender to be placed in an idle status pending specific events which trigger reawakening to an active status.

The recitation herein of a list of desirable objects which are met by various embodiments of the present invention is not meant to imply or suggest that any or all of these objects are present as essential features, either individually or collectively, in the most general embodiment of the present invention or in any of its more specific embodiments.

### DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a block diagram illustrating the environment in which the present invention operates; and

FIG. 2 is a block diagram illustrating the message sending and receiving process and protocol employed in preferred embodiments in the present invention.

### DETAILED DESCRIPTION OF THE INVENTION

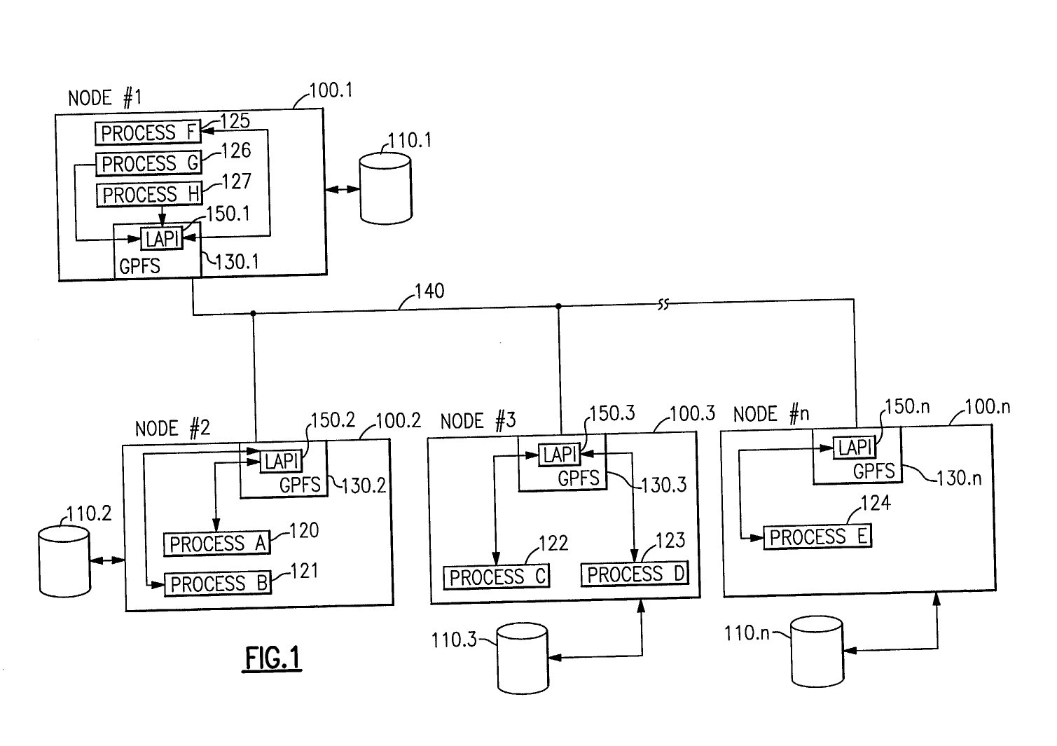

FIG. 1 illustrates, in block diagram form, an exemplary environment in which the present invention operates and functions. In particular, a plurality of nodes (100.1 through 100.n) are connected by means of a network connection 140. In preferred embodiments of the present invention network 140 comprises the switch in an IBM SP product now part of the p-series products. Each node (100.x) includes one or more processes (such as those identified by reference numerals 120 through 127) that may be running on one or more nodes, as shown. Each node 100.x also includes one or more file storage devices such as 110.x, as shown. Each node also preferably includes program code referred to as GPFS, the General Parallel File Server System, which is employed for accessing data files from one node in situations where the desired files reside on file server devices (such as the disk drives shown) which are attached to other nodes. GPFS also makes use of a Low Level Application Program Interface (LAPI) which is included (150.1 through 150.n) and which is located on all nodes of the cluster which also have the GPFS system running on the respective nodes. GPFS running on the various nodes has, from time to time, a need to send token control messages to other GPFS processes running on other nodes. These are often messages for which a response from the receiving node is expected.

It is inefficient for the sending process to be reawakened every time that one of the nodes to which a message is sent in return sends a reply message back to the original sending node. Reawakening the sending process upon receipt of each reply is wasteful of CPU cycle time at the node on which the sending process resides.

Since one of the objects and functions of the present invention is to send a message to a plurality of identifiable nodes, all of which are expected to send a reply to the sending node, a number of possible outcomes have to be considered. In the ideal case message Y is sent to and received by all of the receivers and all of the receivers send a response X back to the sending node. In one fault scenario it is possible that some of the responses X do not reach the sender. In a different scenario it is possible that some of the messages Y do not reach the receivers in which case responses X from those nodes will not reach the sender. It is possible that a receiver goes down or fails before it receives a message request. It is also possible that a receiver goes down after it has received the request from the sender but before it has had a chance to send a response. And a last possible scenario is one in which a receiver fails after it sends a response back to the sender. Flexibility in addressing all of these possible scenarios in a uniform and efficient manner is a desired object in message passing systems.

In the examples provided herein, it is noted that, for ease of presentation and understanding, the same message Y is assumed to be sent to each node. However, the present invention is not so limited. In particular, different messages can be sent to different nodes without departing from the scope or purpose of the present invention. The sender can indeed select different messages Y₁, Y₂, . . . , Yₙ to go to each receiver node. Each receiver can send a different (or the same) response back to the sender.

In order to best carry out the operations of the present invention, the applicants have defined two additional interface subroutines as part of the Low Level API library (LAPI) which is used by GPFS as an efficient mechanism for message transport. The first of these is called LAPI_Setcntr_wstatus. This subroutine sets a counter to a specified value and sets the associated destination list array and destination status array to the counter value. A second subroutine is also defined and is referred to as the LAPI_Nopoll_wait subroutine. This provides a counter value, a list of destinations from which a response associated with the counter is expected, and a state to be updated once the counter value is reached. These two subroutines and their usages and descriptions are more particularly described in Appendix I below.

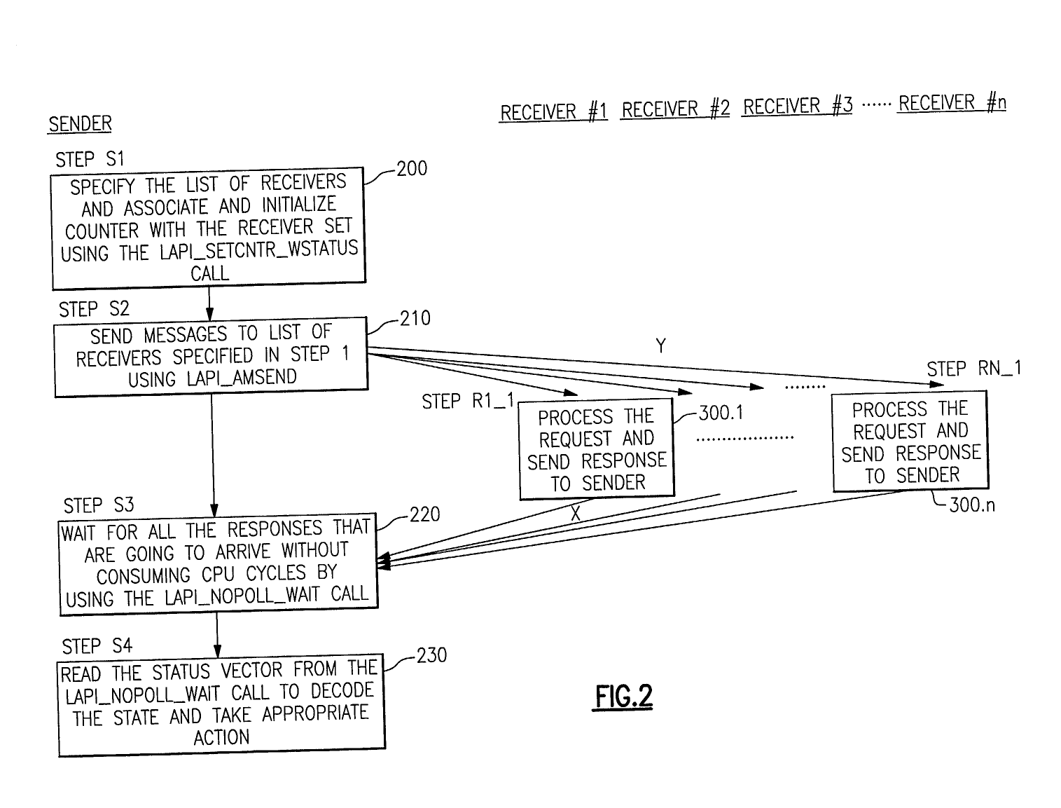

The specific operation of these two subroutines in the context of the present method is now more particularly described and characterized. In particular, attention is directed to FIG. 2 and in particular to Step S1 (reference numeral 200). Before actually sending a message, a process running on the sender node makes a call to the LAPI_Setcntr_wstatus function and passes information to this routine such as the list of receiver nodes to which it is planning to send this message, and a buffer sufficient to save reply status information received from each process running on the receiving nodes. It is in this buffer that information is maintained which determines whether or not a receiver has sent its reply and if not, the reason for not receiving it. The LAPI_Setscntr_wstatus function performs the following operations. It sets a counter to zero and later increments by one for each reply it receives. This function also performs status vector initialization. It is noted that for purposes of the present invention, it is also implementable via counters that are decremented from a fixed number until a zero entry is detected in the counter. However, this is not the preferred mechanism.

In Step 2 (reference numeral 210), following the return from the above function call (LAPI_Setcntr_wstatus), the sender makes another function call to LAPI_Amsend which is the function which is used to send the messages to each of the receivers. This is a standard function which has already been provided in earlier publicly available p-series systems. (See U.S. Pat. No. 6,038,604 which is also assigned to the same assignee as the present invention.) LAPI_Amsend function is used to send the message to all of the receivers. If it fails to send this message to any receiver, because the receiver is down or not operational, it decrements a counter and updates the status vector corresponding to that receiver.

The various receivers that do receive the messages process the request and generally operate to send a response back to the sender.

In Step 3 (reference numeral 220) after sending message Y to all of the receivers, the calling process makes a second function call to LAPI_nopoll_wait which causes the process to enter an inactive or “sleep” state.

While the sending process is in the inactive state, the LAPI library system reads data supplied from network 140. The LAPI library decodes the message packets and updates the status vector corresponding to that receiver and decrements the counter. Any node failures are reported to the GPFS software through the group services function. When this happens, the GPFS program tells the LAPI program to stop waiting for a reply for that failed receiver. LAPI then updates the corresponding status vector. When the status vector and counter reflect the fact that all messages that will arrive have arrived, LAPI wakes up the calling process which is awaiting this call as a result of operations carried out in Step 3 with respect to the LAPI_nopoll_wait function described above.

In Step 4 the calling process (GPFS) reads the status vector from the LAPI_nopoll_wait function to decode state and to take any appropriate action.

In general the status vector preferably indicates the following information:

(1) the receiver failed before receiving the message from the sender;

(2) the receiver failed after receiving the message but before sending a reply;

(3) the receiver failed after sending a reply back to the sender;

(4) the sender received the reply successfully;

(5) the receiver received a reply; or

(6) the receiver failed before sending a reply.

From the above, it should be appreciated that the present invention provides two interface mechanisms for interaction between a process running on one node with the LAPI library to effect an efficient message transfer to various receiving nodes. More particularly, from the above it should be appreciated that the present invention provides not only an interface for improved messaging functionality but also provides a mechanism in which the sending process does not consume CPU cycles while awaiting a response from the receivers. It is also seen that the present invention provides programming hooks for other applications to effect recovery operations that may be necessary or desirable. In particular, it is seen that the calling process is not put into a reawakened or active state until the receipt of responses to all of the nodes or until receipt of notification that at least one response is not forthcoming.

While the invention has been described in detail herein in accordance with certain preferred embodiments thereof, many modifications and changes therein may be effected by those skilled in the art. Accordingly, it is intended by the appended claims to cover all such modifications and changes as fall within the true spirit and scope of the invention.

[image]

[image]

[image]

[image]

The invention claimed is:

1. A method for message processing in a distributed data processing system having a plurality of nodes, said method comprising the steps of:
sending a plurality of messages from a process running on one of the nodes in the system to an equal plurality of other nodes in the system;
setting the status of said sending process to idle; and
changing the status of said sending process to “active” upon receipt of responses to said messages from all of said other nodes or upon receipt of notification that at least one response will not arrive.

2. The method of claim 1 further including the step of processing, by said sending process, said responses to said messages.

3. The method of claim 1 in which, prior to sending said message, said sending process selects a subset of nodes within said data processing system for receipt of said message.

4. The method of claim 1 in which said messages sent to said plurality of nodes are all the same.

5. A data processing system comprising:
a plurality of nodes connected by a network for sending messages between said nodes;
a plurality of message processing programs each being stored in one of said nodes;
a message sending process program residing in one of said nodes and being capable of entering an inactive state;
a message processing interface program, residing on said one node and being capable of (1) sending a plurality of messages in response to requests from said sending process program, said messages being directed to an equal plurality of nodes selected to receive said messages (2) setting the status of said sending process to inactive, and (3) changing the status of said sending process to active upon receipt of responses to said messages from all of said selected nodes or upon receipt of notification that at least one response will not arrive.

6. The system of claim 5 in which said interface also includes program code for responding to selection of a subset of destination nodes by said sending process program.

7. The system of claim 5 in which said sending process program is capable of processing said responses.

8. The system of claim 5 in which said messages sent to said plurality of nodes are all the same.

9. A computer program product stored within or on a machine readable medium containing program means for use in an interconnected network of data processing nodes said program means being operative:
to send a plurality of messages message from a process running on one of the nodes in the system to an equal plurality of other nodes in the system;
to set the status of said sending process to idle; and
to change the status of said sending process to “active” upon receipt of responses to said messages from all of said other nodes or upon receipt of notification that at least one response will not arrive.
